(19) United States
(12) Patent Application Publication
(10) Pub. No.: US 2019/0255971 A1
(43) Pub. Date: Aug. 22, 2019

(54) SEAT DEVICE FOR VEHICLE

(71) Applicant: AISIN SEIKI KABUSHIKI KAISHA, Kariya-shi (JP)

(72) Inventor: Yuki SAKATO, lchinomiya-shi (JP)

(73) Assignee: AISIN SEIKI KABUSHIKI KAISHA, Kariya-shi (JP)

(21) Appl. No.: 16/269,635

(22) Filed: Feb. 7, 2019

(30) Foreign Application Priority Data
Feb. 16, 2018 (JP) 2018-026024

(51) Int. Cl. B60N 2/02; B60N 2/90

(52) U.S. Cl. CPC B60N 2/0244; B60N 2/99; B60N 2/976; B60N 2/0232

(57) ABSTRACT

A seat device for a vehicle includes: a seat having a side support portion pivotable to hold a lateral portion of an occupants upper body; and a control device configured to control at least an operation of the side support portion. The control device includes: an acquisition unit configured to acquire physical quantities from detection devices detecting the physical quantities related to lateral accelerations occurring in a direction orthogonal to a proceeding direction; a deviation calculating unit configured to calculate deviations of the lateral accelerations derivable from the physical quantities; a determination unit configured to determine an abnormal lateral acceleration among the lateral accelerations; and a control unit configured to control the operation of the side support portion in accordance with a normal lateral acceleration other than the abnormal lateral acceleration determined by the determination unit, among the lateral accelerations.

### CROSS REFERENCE TO RELATED APPLICATIONS

This application is based on and claims priority under 35 U.S.C. § 119 to Japanese Patent Application 2018-026024, filed on Feb. 16, 2018, the entire contents of which are incorporated herein by reference.

### TECHNICAL FIELD

This disclosure relates to a seat device for a vehicle.

### BACKGROUND DISCUSSION

In the related art, for example, a seat device for a vehicle disclosed in JP 2008-126821 A (Reference 1) has been known. The seat device for a vehicle in the related art is configured such that based on input information acquired from a car navigation system, a vehicle speed sensor, a lateral acceleration sensor, and the like, a seat support ECU determines whether a vehicle travels on a continuous curve and then performs automatic seat support control on a support operation of a side support portion.

By the way, in the seat device for a vehicle in the related art, based on input information (physical quantity), the seat support ECU (control device) controls the support operation of the side support portion when the vehicle travels on a curve. In this case, to allow the side support portion to perform appropriately and stably the support operation, the control device needs to perform the automatic seat support control by using normal physical quantities which indicate that the vehicle travels on the curve, in other words, which are related to a lateral acceleration occurring in the vehicle.

Thus, a need exists for a seat device for a vehicle which is not susceptible to the drawback mentioned above.

### SUMMARY

A seat device for a vehicle according to an aspect of this disclosure includes: a seat having a side support portion that is pivotable to hold a lateral portion of an occupant's upper body; and a control device configured to control at least an operation of the side support portion, in which the control device includes: an acquisition unit configured to acquire physical quantities from three or more different detection devices that detect the physical quantities related to lateral accelerations occurring in a direction orthogonal to a proceeding direction of a vehicle; a deviation calculating unit configured to calculate deviations of the lateral accelerations derivable from the physical quantities acquired by the acquisition unit; a determination unit configured to determine, as an abnormal lateral acceleration, a lateral acceleration at which the deviation calculated by the deviation calculating unit is equal to or higher than a predetermined value, among the lateral accelerations; and a control unit configured to control the operation of the side support portion in accordance with a normal lateral acceleration other than the abnormal lateral acceleration determined by the determination unit, among the lateral accelerations.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a seat device for a vehicle according to an embodiment;

FIG. 2 is a top plan view of the seat device for a vehicle in FIG. 1;

FIG. 3 is a block diagram illustrating a configuration of a control device of the embodiment;

FIG. 4 is a flowchart of an abnormal lateral acceleration determination program executed by the control device in FIG. 3;

FIG. 5 is a flowchart of a controllability determination program executed by the control device in FIG. 3;

FIG. 6 is a flowchart of a lateral acceleration usage determination program executed by the control device in FIG. 3; and

FIG. 7 is a perspective view of a seat device for a vehicle according to a modification of the embodiment.

### DETAILED DESCRIPTION

Hereinafter, embodiments of the present disclosure (hereinafter, referred to as “the present embodiment”) will be described with reference to the drawings. In addition, in the following embodiment and the modification, parts, which are identical or equivalent to one another, are denoted by the same reference numeral. Further, the drawings used for the description are conceptual views and shapes of the respective parts sometimes are not necessarily exact.

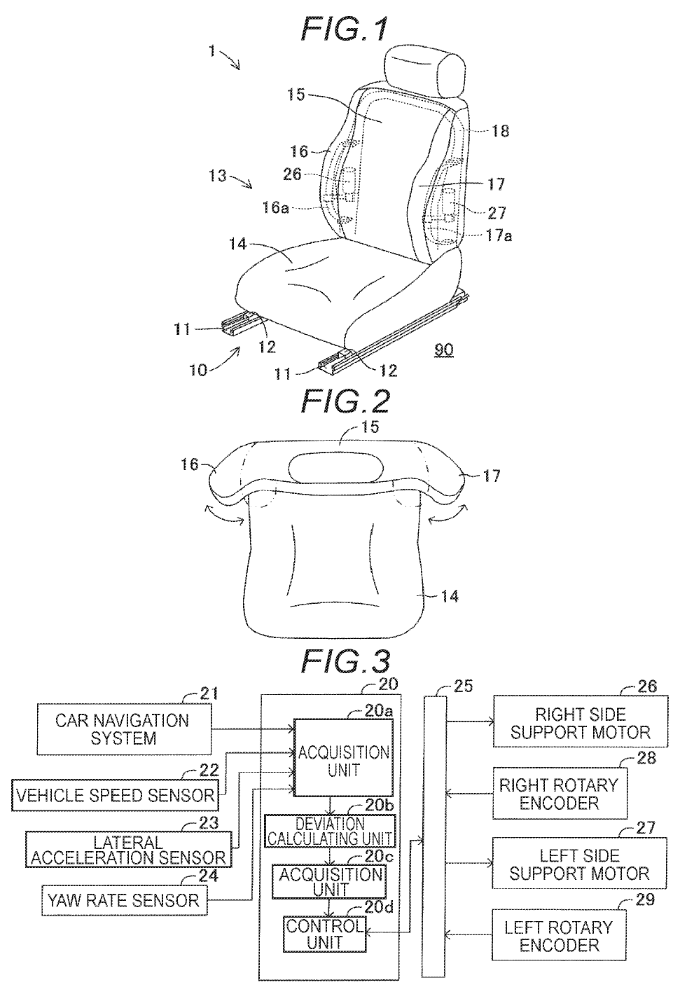

As illustrated in FIG. 1, a seat device 1 for a vehicle according to the present embodiment has a seat slide device 10 and a seat 13. The seat slide device 10 includes a pair of lower rails 11 which is fixed onto a floor 90 and extends in a front and rear direction of a vehicle, and upper rails 12 which are retained to be movable relative to the lower rails 11. The seat 13 has a seat cushion 14 on which an occupant is seated, and a seatback 15 which supports a back (back portion) of the occupant. A right side support portion 16 and a left side support portion 17, which stabilize a posture of the occupant by pressing the occupant's upper body from lateral sides, are provided at a right side and a left side of the seatback 15, respectively.

In addition, a right side support motor 26 and a left side support motor 27, which each have a speed reduction mechanism, are provided at a right side and a left side of the seat frame 18. The right side support motor 26 and the left side support motor 27 allow a right support frame 16a and a left support frame 17a to be pivotable. The right support frame 16a and the left support frame 17a pivot as the right side support motor 26 and the left side support motor 27 operate, such that as illustrated in FIG. 2, the right side support portion 16 and the left side support portion 17 are opened or closed. In addition, the right side support portion 16 and the left side support portion 17 constitute side support portions.

The operations of the right side support motor 26 and the left side support motor 27 are controlled by an electronic control unit 20 (hereinafter, simply referred to as an “ECU 20”) as a control device. The ECU 20 is a microcomputer which includes main constituent components such as a CPU, a ROM, and a RAM (all not illustrated), and as illustrated in FIG. 3, a car navigation system 21 as a detection device mounted in the vehicle, a vehicle speed sensor 22, a lateral acceleration sensor 23 as a detection device, a yaw rate sensor 24 as a detection device, and a drive circuit 25 are connected to the ECU 20.

The car navigation system 21 detects positions and proceeding directions of the vehicle by inputting GPS signals and informs of a path by matching (map matching) the detected position and proceeding direction of the vehicle with electronic map data stored in advance in an updatable manner. Further, the car navigation system 21 outputs, to the ECU 20, an electrical signal (voltage) that indicates a lateral acceleration which is estimated by the map matching, as occurring in the vehicle (hereinafter, referred to as a “navigator-estimated lateral acceleration Gn”), as a physical quantity related to a lateral acceleration applied in a direction orthogonal to the proceeding direction of the vehicle.

The vehicle speed sensor 22 detects a speed of the vehicle, that is, a vehicle speed V and outputs an electrical signal (voltage), which indicates the vehicle speed V, to the ECU 20 and the car navigation system 21. Here, to estimate the navigator-estimated lateral acceleration Gn, for example, the car navigation system 21 acquires a radius of curvature of a traveling path, along which the vehicle travels, from the electronic map data, acquires the vehicle speed V from the vehicle speed sensor 22, and estimates the navigator-estimated lateral acceleration Gn by the map matching using the radius of curvature and the vehicle speed V. The lateral acceleration sensor 23 is provided in the vehicle and outputs, to the ECU 20, an electrical signal (voltage), as a physical quantity, that indicates an actual lateral acceleration occurring in the vehicle (hereinafter, referred to as an “actual lateral acceleration Gr”). The yaw rate sensor 24 is provided in the vehicle and outputs, as a physical quantity, an electrical signal (voltage) that indicates a yaw rate occurring in the vehicle due to turning of the vehicle in accordance with a steering angle of a steering wheel, to the ECU 20. Therefore, the ECU 20 calculates a lateral acceleration derived (estimated) from the yaw rate outputted from the yaw rate sensor 24 (hereinafter, referred to as a “steering-angle-estimated lateral acceleration Gs”).

As illustrated in FIG. 3, the ECU 20 has an acquisition unit 20a, a deviation calculating unit 20b, a determination unit 20c, and a control unit 20d. The acquisition unit 20a acquires physical quantities from the three detection devices, which are the car navigation system 21, the lateral acceleration sensor 23, and the yaw rate sensor 24.

The deviation calculating unit 20b calculates differential values Gd that indicate deviations related to the navigator-estimated lateral acceleration Gn, the actual lateral acceleration Gr, and the steering-angle-estimated lateral acceleration Gs which are acquired by the acquisition unit 20a. Specifically, the deviation calculating unit 20b determines, as a reference value, a lateral acceleration present between a maximum value and a minimum value of the acquired navigator-estimated lateral acceleration Gn, the acquired actual lateral acceleration Gr, and the acquired steering-angle-estimated lateral acceleration Gs, and calculates the differential values Gd, which are the deviations related to the navigator-estimated lateral acceleration Gn, the actual lateral acceleration Gr, and the steering-angle-estimated lateral acceleration Gs with respect to the reference value.

The determination unit 20c determines, as an abnormal lateral acceleration, a lateral acceleration when the differential values Gd calculated, by the deviation calculating unit 20b, related to the navigator-estimated lateral acceleration Gn, the actual lateral acceleration Gr, and the steering-angle-estimated lateral acceleration Gs are equal to or higher than a predetermined value Gth.

The control unit 20d automatically controls the operations of the right side support motor 26 and the left side support motor 27 through the drive circuit 25 in accordance with a normal lateral acceleration other than the abnormal lateral acceleration determined, by the determination unit 20c, from the navigator-estimated lateral acceleration Gn, the actual lateral acceleration Gr, and the steering-angle-estimated lateral acceleration Gs. In addition, in the following description, the process of the control unit 20d automatically controlling the operations of the right side support motor 26 and the left side support motor 27 is referred to as “automatic seat support control.” Specifically, the control unit 20d outputs driving signals to the right side support motor 26 and the left side support motor 27 through the drive circuit 25 and inputs position signals for feedback control from a right rotary encoder 28 provided in the right side support motor 26 and a left rotary encoder 29 provided in the left side support motor.

In the seat device 1 for a vehicle according to the embodiment configured as described above, the right side support portion 16 and the left side support portion 17 are operated by the operation control of the ECU 20, thereby supporting lateral portions of the occupant. The automatic seat support control, which automatically operates the right side support portion 16 and the left side support portion 17, is performed by at least one of a navigator cooperation control program and an autonomous control program stored in the ROM of the ECU 20.

The navigator cooperation control program operates the right side support portion 16 and the left side support portion 17 through the automatic seat support control based on the electronic map data from the car navigation system 21. Further, the navigator cooperation control program determines whether it is necessary to maintain the operated right side support portion 16 and the operated left side support portion 17, and when the navigator cooperation control program determines that it is necessary to maintain the right side support portion 16 and the left side support portion 17, the navigator cooperation control program performs maintenance control on the right side support portion 16 and the left side support portion 17. Here, the maintenance control refers to control that keeps the right side support portion 16 and the left side support portion 17 at support positions of a straight portion between curves of the traveling path.

The autonomous control program operates the right side support portion 16 and the left side support portion 17 through the automatic seat support control in a state where the vehicle turns in a moving state. Further, the autonomous control program determines whether it is necessary to maintain the operated right side support portion 16 and the operated left side support portion 17, and when the autonomous control program determines that it is necessary to maintain the right side support portion 16 and the left side support portion 17, the autonomous control program performs maintenance control on the right side support portion 16 and the left side support portion 17. In addition, because the navigator cooperation control program and the autonomous control program are identical to those in the seat device for a vehicle in the related art, a description thereof will be omitted.

By the way, the ECU 20 executes the navigator cooperation control program and the autonomous control program, thereby automatically operating the right side support portion 16 and the left side support portion 17 by performing the automatic seat support control in a situation in which the occupants upper body may lean toward the left and the right. That is, the ECU 20 performs the automatic seat support control by using the navigator-estimated lateral acceleration Gn, the actual lateral acceleration Gr, and the steering-angle-estimated lateral acceleration Gs. In this case, the navigator-estimated lateral acceleration Gn, the actual lateral acceleration Gr, and the steering-angle-estimated lateral acceleration Gs need to be the normal lateral acceleration, not the abnormal lateral acceleration, so that the ECU 20 appropriately operates by performing the automatic seat support control in the situation in which the occupants upper body leans toward the left and right. Therefore, the ECU 20 executes an abnormal lateral acceleration determination program that determines whether the navigator-estimated lateral acceleration Gn, the actual lateral acceleration Gr, and the steering-angle-estimated lateral acceleration Gs are the abnormal lateral accelerations, in other words, determines whether the navigator-estimated lateral acceleration Gn, the actual lateral acceleration Gr, and the steering-angle-estimated lateral acceleration Gs are the normal lateral accelerations. Hereinafter, the abnormal lateral acceleration determination program will be specifically described.

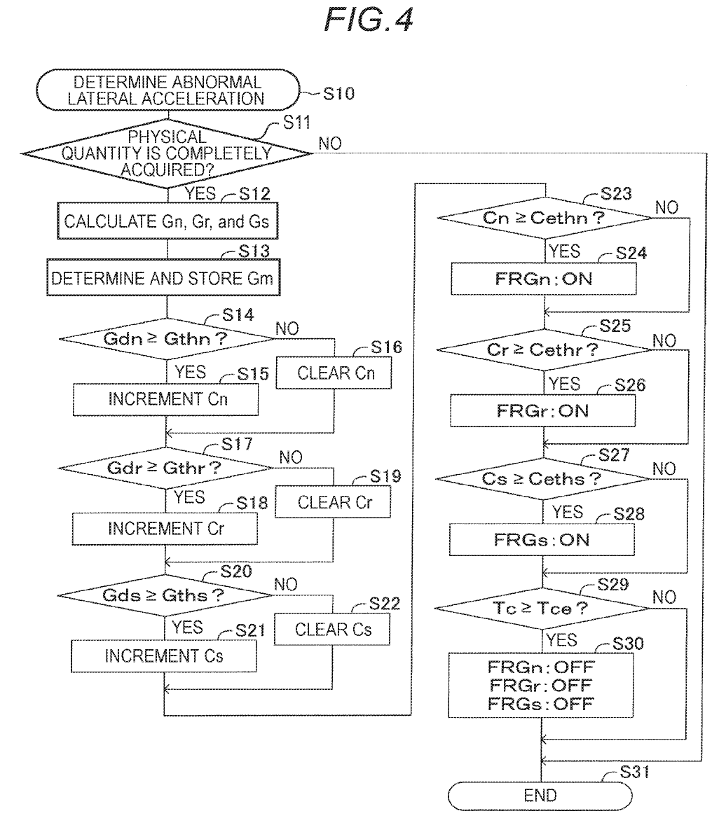

The ECU 20 (the CPU in more detail, the same applies hereinafter) begins to perform the abnormal lateral acceleration determination program illustrated in FIG. 4 in step S10. In next step S11, the ECU 20 (acquisition unit 20a) acquires information in which a detection interval (sampling cycle) is longest regarding the yaw rates which are the physical quantities related to the navigator-estimated lateral acceleration Gn, the actual lateral acceleration Gr, and the steering-angle-estimated lateral acceleration Gs which are acquired information, that is, for example, a signal that indicates the navigator-estimated lateral acceleration Gn, and determines whether the previous information acquired by executing the previous program is updated. That is, the ECU 20 determines “Yes” when the signal, which indicates the navigator-estimated lateral acceleration Gn of which the sampling cycle is longest, is completely acquired, that is, when the previous information acquired by executing the previous program is updated by the present information acquired by executing the present program, and the ECU 20 proceeds to step S12.

Meanwhile, the ECU 20 (acquisition unit 20a) determines “No” in step S11 when the signal, which indicates the navigator-estimated lateral acceleration Gn that is information of the longest sampling cycle, is not yet completely acquired when performing the present program. Further, in this case, the ECU 20 proceeds to step S31 based on the “No” determination in step S11 until the signal indicating the navigator-estimated lateral acceleration Gn is completely acquired, that is, until “Yes” is determined in step S11, ends the execution of the program, and then starts the execution of the program in step S10 after a short time is elapsed.

In step S12, the ECU 20 (deviation calculating unit 20b) calculates the navigator-estimated lateral acceleration Gn, the actual lateral acceleration Gr, and the steering-angle-estimated lateral acceleration Gs based on the signal acquired in step S11 by executing the present program. Further, when the navigator-estimated lateral acceleration Gn, the actual lateral acceleration Gr, and the steering-angle-estimated lateral acceleration Gs are calculated, the ECU 20 proceeds to step S13.

In step S13, the ECU 20 (deviation calculating unit 20b) determines, as a reference value, a median Gm which is a central value of the navigator-estimated lateral acceleration Gn, the actual lateral acceleration Gr, and the steering-angle-estimated lateral acceleration Gs calculated in step S12, and temporarily stores the median, for example, in the RAM (not illustrated). Further, when the median Gm is temporarily stored, the ECU 20 proceeds to step S14.

In step S14, the ECU 20 (deviation calculating unit 20b) calculates the differential value Gd which is a deviation. Specifically, the ECU 20 (deviation calculating unit 20b) calculates a differential value Gdn which is a deviation between the navigator-estimated lateral acceleration Gn calculated in step S12 and the median Gm temporarily stored in step S13.

The ECU 20 (determination unit 20c) determines whether the calculated differential value Gdn is equal to or higher than a predetermined value Gthn (equal to or higher than a predetermined value). Specifically, when the differential value Gdn is equal to or higher than the predetermined value Gthn, the ECU 20 (determination unit 20c) determines “Yes” and proceeds to step S15 because the navigator-estimated lateral acceleration Gn is considerably distant from the median Gm and different from the tendency of the median Gm (e.g., a direction in which the lateral acceleration is applied, a magnitude of the lateral acceleration, or the like), that is, because the navigator-estimated lateral acceleration Gn is the abnormal lateral acceleration.

In step S15, because the navigator-estimated lateral acceleration Gn is the abnormal lateral acceleration, the ECU 20 (determination unit 20c) increments, by “1,” a navigator-estimated lateral acceleration abnormality continuation count Cn that indicates continuation of the abnormal lateral acceleration. Here, an initial value of the navigator-estimated lateral acceleration abnormality continuation count Cn is set to “0.” In addition, the increment amount is not limited to “1.” Further, when the navigator-estimated lateral acceleration abnormality continuation count Cn is incremented, the ECU 20 proceeds to step S17.

Meanwhile, when the differential value Gdn of the navigator-estimated lateral acceleration Gn is lower than the predetermined value Gthn (lower than a predetermined value), the ECU 20 (determination unit 20c), in step S14, determines that the navigator-estimated lateral acceleration Gn is not considerably distant from the median Gm. In this case, because the tendency of the navigator-estimated lateral acceleration Gn is identical to (coincident with) the tendency of the median Gm, the ECU 20 determines “No” in step S14 and proceeds to step S16. That is, in this case, the navigator-estimated lateral acceleration Gn is the normal lateral acceleration.

In step S16, the ECU 20 (determination unit 20c) clears (resets) the navigator-estimated lateral acceleration abnormality continuation count Cn. The reason is that when it is determined that the differential value Gdn is lower than the predetermined value Gthn in the determination process in step S14, the navigator-estimated lateral acceleration Gn is the normal lateral acceleration or the navigator-estimated lateral acceleration Gn returns to the normal lateral acceleration from a state where the navigator-estimated lateral acceleration Gn is temporarily the abnormal lateral acceleration. Further, when the navigator-estimated lateral acceleration abnormality continuation count Cn is cleared (reset), the ECU 20 proceeds to step S17.

In step S17, the ECU 20 (deviation calculating unit 20b) calculates a differential value Gdr which is a deviation between the actual lateral acceleration Gr calculated in step S12 and the median Gm temporarily stored in step S13.

The ECU 20 (determination unit 20c) determines whether the calculated differential value Gdr is equal to or higher than a predetermined value Gthr (equal to or higher than a predetermined value). Specifically, when the differential value Gdr is equal to or higher than the predetermined value Gthr, the ECU 20 (determination unit 20c) determines “Yes” and proceeds to step S18 because the actual lateral acceleration Gr is considerably distant from the median Gm and different from the tendency of the median Gm, that is, because the actual lateral acceleration Gr is the abnormal lateral acceleration.

In step S18, because the actual lateral acceleration Gr is the abnormal lateral acceleration, the ECU 20 (determination unit 20c) increments, by “1,” an actual lateral acceleration abnormality continuation count Cr that indicates continuation of the abnormal lateral acceleration. In addition, even in the case of the actual lateral acceleration abnormality continuation count Cr, the increment amount is not limited to “1.” Further, when the actual lateral acceleration abnormality continuation count Cr is incremented, the ECU 20 proceeds to step S20.

Meanwhile, when the differential value Gdr of the actual lateral acceleration Gr is lower than a predetermined value Gthr (lower than a predetermined value), the ECU 20 (determination unit 20c), in step S17, determines that the actual lateral acceleration Gr is not considerably distant from the median Gm. In this case, because the tendency of the actual lateral acceleration Gr is identical to (coincident with) the tendency of the median Gm, the ECU 20 determines “No” in step S17 and proceeds to step S19. That is, in this case, the actual lateral acceleration Gr is the normal lateral acceleration.

In step S19, the ECU 20 (determination unit 20c) clears (resets) the actual lateral acceleration abnormality continuation count Cr. Similar to the navigator-estimated lateral acceleration Gn, the reason is that when it is determined that the differential value Gdr is lower than the predetermined value Gthr in the determination process in step S17, the actual lateral acceleration Gr is the normal lateral acceleration or the actual lateral acceleration Gr returns to the normal lateral acceleration from a state where the actual lateral acceleration Gr is temporarily the abnormal lateral acceleration. Further, when the actual lateral acceleration abnormality continuation count Cr is cleared (reset), the ECU 20 proceeds to step S20.

In step S20, the ECU 20 (deviation calculating unit 20b) calculates a differential value Gds which is a deviation between the steering-angle-estimated lateral acceleration Gs calculated in step S12 and the median Gm temporarily stored in step S13.

The ECU 20 (determination unit 20c) determines whether the calculated differential value Gds is equal to or higher than a predetermined value Gths (equal to or higher than a predetermined value). Specifically, when the differential value Gds is equal to or higher than the predetermined value Gths, the ECU 20 (determination unit 20c) determines “Yes” and proceeds to step S21 because the steering-angle-estimated lateral acceleration Gs is considerably distant from the median Gm and different from the tendency of the median Gm, that is, because the steering-angle-estimated lateral acceleration Gs is the abnormal lateral acceleration.

In step S21, because the steering-angle-estimated lateral acceleration Gs is the abnormal lateral acceleration, the ECU 20 (determination unit 20c) increments, by “1,” a steering-angle-estimated lateral acceleration abnormality continuation count Cs that indicates continuation of the abnormal lateral acceleration. In addition, even in the case of the steering-angle-estimated lateral acceleration abnormality continuation count Cs, the increment amount is not limited to “1.” Further, when the steering-angle-estimated lateral acceleration abnormality continuation count Cs is incremented, the ECU 20 proceeds to step S23.

Meanwhile, when the differential value Gds of the steering-angle-estimated lateral acceleration Gs is lower than the predetermined value Gths (lower than the predetermined value), the ECU 20 (determination unit 20c), in step S20, determines that the steering-angle-estimated lateral acceleration Gs is not considerably distant from the median Gm. In this case, because the tendency of the steering-angle-estimated lateral acceleration Gs is identical to (coincident with) the tendency of the median Gm, the ECU 20 determines “No” in step S20 and proceeds to step S22. That is, in this case, the steering-angle-estimated lateral acceleration Gs is the normal lateral acceleration.

In step S22, the ECU 20 (determination unit 20c) clears (resets) the steering-angle-estimated lateral acceleration abnormality continuation count Cs. Similar to the navigator-estimated lateral acceleration Gn and the actual lateral acceleration Gr, the reason is that when the differential value Gds is lower than the predetermined value Gths in the determination process in step S20, the steering-angle-estimated lateral acceleration Gs is the normal lateral acceleration or the steering-angle-estimated lateral acceleration Gs returns to the normal lateral acceleration from a state where the steering-angle-estimated lateral acceleration Gs is temporarily the abnormal lateral acceleration. Further, when the steering-angle-estimated lateral acceleration abnormality continuation count Cs is cleared (reset), the ECU 20 proceeds to step S23.

In step S23, the ECU 20 (determination unit 20c) determines whether the navigator-estimated lateral acceleration abnormality continuation count Cn (the number of times) incremented in step S15 or step S16, particularly, step S15 is equal to or larger than a determination count Cethn (equal to or larger than a predetermined number of times) which is a predetermined number of times. That is, when the navigator-estimated lateral acceleration abnormality continuation count Cn is equal to or larger than the determination count Cethn, the ECU 20 (determination unit 20c) determines “Yes” and proceeds to step S24. Meanwhile, when the navigator-estimated lateral acceleration abnormality continuation count Cn is smaller than the determination count Cethn (smaller than the predetermined number of times), the ECU 20 (determination unit 20c) determines “No” and proceeds to step S25. In addition, as described above, in step S16, the navigator-estimated lateral acceleration abnormality continuation count Cn is cleared (reset). Therefore, when the navigator-estimated lateral acceleration abnormality continuation count Cn is cleared (reset) in step S16, the ECU 20 (determination unit 20c) determines “No” and proceeds to step S25 because the navigator-estimated lateral acceleration abnormality continuation count Cn is smaller than the determination count Cethn.

In step S24, the ECU 20 (determination unit 20c) changes a value of a navigator input abnormality flag FRGn, which indicates that the navigator-estimated lateral acceleration Gn inputted from the car navigation system 21 is the abnormal lateral acceleration, that is, for example, changes the value from “0” of the initial value to “1.” Therefore, the ECU 20 (determination unit 20c) switches the navigator input abnormality flag FRGn to the ON state. When the navigator input abnormality flag FRGn is switched to the ON state, the ECU 20 proceeds to step S25.

In step S25, the ECU 20 (determination unit 20c) determines whether the actual lateral acceleration abnormality continuation count Cr (the number of times) incremented in step S18 or step S19, particularly, step S18 is equal to or larger than a determination count Cethr (equal to or larger than a predetermined number of times) which is a predetermined number of times. That is, when the actual lateral acceleration abnormality continuation count Cr is equal to or larger than the determination count Cethr, the ECU 20 (determination unit 20c) determines “Yes” and proceeds to step S26. Meanwhile, when the actual lateral acceleration abnormality continuation count Cr is smaller than the determination count Cethr (smaller than the predetermined number of times), the ECU 20 (determination unit 20c) determines “No” and proceeds to step S27. In addition, as described above, in step S19, the actual lateral acceleration abnormality continuation count Cr is cleared (reset). Therefore, when the actual lateral acceleration abnormality continuation count Cr is cleared (reset) in step S19, the ECU 20 (determination unit 20c) determines “No” and proceeds to step S27 because the actual lateral acceleration abnormality continuation count Cr is smaller than the determination count Cethr.

In step S26, the ECU 20 (determination unit 20c) changes a value of a lateral acceleration sensor input abnormality flag FRGr, which indicates that the actual lateral acceleration Gr inputted from the lateral acceleration sensor 23 is the abnormal lateral acceleration, that is, for example, changes the value from “0” of the initial value to “1.” Therefore, the ECU 20 (determination unit 20c) switches the lateral acceleration sensor input abnormality flag FRGr to the ON state. When the lateral acceleration sensor input abnormality flag FRGr is switched to the ON state, the ECU 20 proceeds to step S27.

In step S27, the ECU 20 (determination unit 20c) determines whether the steering-angle-estimated lateral acceleration abnormality continuation count Cs (the number of times) incremented in step S21 or step S22, particularly, step S21 is equal to or larger than a determination count Ceths (equal to or larger than a predetermined number of times) which is a predetermined number of times. That is, when the steering-angle-estimated lateral acceleration abnormality continuation count Cs is equal to or larger than the determination count Ceths, the ECU 20 (determination unit 20c) determines “Yes” and proceeds to step S28. Meanwhile, when the steering-angle-estimated lateral acceleration abnormality continuation count Cs is smaller than the determination count Ceths (smaller than the predetermined number of times), the ECU 20 (determination unit 20c) determines “No” and proceeds to step S29. In addition, as described above, in step S22, the steering-angle-estimated lateral acceleration abnormality continuation count Cs is cleared (reset). Therefore, when the steering-angle-estimated lateral acceleration abnormality continuation count Cs is cleared (reset) in step S22, the ECU 20 (determination unit 20c) determines “No” and proceeds to step S29 because the steering-angle-estimated lateral acceleration abnormality continuation count Cs is smaller than the determination count Ceths.

In step S28, the ECU 20 (determination unit 20c) changes a value of a steering angle input abnormality flag FRGs, which indicates that the steering-angle-estimated lateral acceleration Gs derived from a yaw rate that is outputted by the yaw rate sensor 24 in accordance with the steering angle, is the abnormal lateral acceleration, that is, for example, changes the value from “0” of the initial value to “1.” Therefore, the ECU 20 (determination unit 20c) switches the steering angle input abnormality flag FRGs to the ON state. When the steering angle input abnormality flag FRGs is switched to the ON state, the ECU 20 proceeds to step S29.

In step S29, the ECU 20 (determination unit 20c) determines whether a duration time Tc for which the navigator-estimated lateral acceleration abnormality continuation count Cn, the actual lateral acceleration abnormality continuation count Cr, and the steering-angle-estimated lateral acceleration abnormality continuation count Cs (hereinafter, collectively and simply referred to as an “abnormality continuation count C”) continues to be “0” is equal to or longer than a predetermined time Tce. In other words, in step S29, the ECU 20 (determination unit 20c) determines whether the abnormality continuation count C is not incremented, that is, the abnormal lateral acceleration is not determined until the predetermined time Tce is elapsed.

Specifically, when the duration time Tc for which the abnormality continuation count C continues to be “0” is equal to or longer than the predetermined time Tce, the ECU 20 (determination unit 20c) determines “Yes” and proceeds to step S30. Meanwhile, when the duration time Tc for which the abnormality continuation count C continues to be “0” is shorter than the predetermined time Tce, that is, when the abnormality continuation count C is incremented until the duration time Tc is elapsed, the ECU 20 (determination unit 20c) determines “No” and proceeds to step S31 and ends the execution of the abnormal lateral acceleration determination program.

In step S30, the ECU 20 (determination unit 20c) changes all of the navigator input abnormality flag FRGn, the lateral acceleration sensor input abnormality flag FRGr, and the steering angle input abnormality flag FRGs to “0.” Therefore, the ECU 20 (determination unit 20c) switches to the OFF state (or maintains) all of the navigator input abnormality flag FRGn, the lateral acceleration sensor input abnormality flag FRGr, and the steering angle input abnormality flag FRGs. That is, in a case where a step process is performed in step S30, none of the navigator-estimated lateral acceleration Gn, the actual lateral acceleration Gr, and the steering-angle-estimated lateral acceleration Gs are the abnormal lateral acceleration. Further, when the step process is performed in step S30, the ECU 20 ends the execution of the abnormal lateral acceleration determination program in step S31.

By the way, the states of the navigator input abnormality flag FRGn, the lateral acceleration sensor input abnormality flag FRGr, and the steering angle input abnormality flag FRGs may be switched by executing the aforementioned abnormal lateral acceleration determination program. Therefore, the ECU 20 (control unit 20d) may appropriately control (perform automatic seat support control on) the operations of the right side support portion 16 and the left side support portion 17 in accordance with the states of the navigator input abnormality flag FRGn, the lateral acceleration sensor input abnormality flag FRGr, and the steering angle input abnormality flag FRGs.

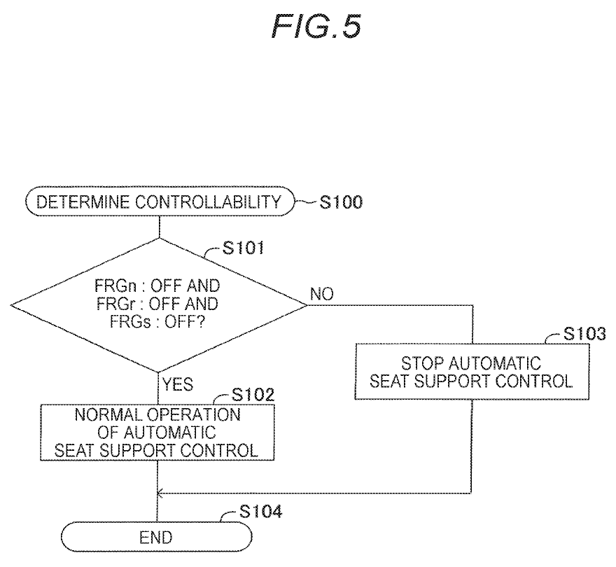

Specifically, when one of the navigator-estimated lateral acceleration Gn, the actual lateral acceleration Gr, and the steering-angle-estimated lateral acceleration Gs becomes the abnormal lateral acceleration and the execution of the automatic seat support control is ended, the ECU 20 may execute a controllability determination program illustrated in FIG. 5. When executing the controllability determination program, the ECU 20 (control unit 20d) starts the controllability determination program in step S100, and in next step S101, the ECU 20 (control unit 20d) determines whether all of the navigator input abnormality flag FRGn, the lateral acceleration sensor input abnormality flag FRGr, and the steering angle input abnormality flag FRGs are in the OFF state, that is, whether the abnormal lateral acceleration does not occur.

That is, when all of the navigator-estimated lateral acceleration Gn, the actual lateral acceleration Gr, and the steering-angle-estimated lateral acceleration Gs are the normal lateral acceleration, the ECU 20 (control unit 20d) determines “Yes” and proceeds to step S102 and normally performs the automatic seat support control (e.g., the aforementioned navigator cooperation control program and the aforementioned autonomous control program). Further, the ECU 20 ends the execution of the controllability determination program in step S104.

Meanwhile, when any one of the navigator-estimated lateral acceleration Gn, the actual lateral acceleration Gr, and the steering-angle-estimated lateral acceleration Gs becomes the abnormal lateral acceleration, in other words, when any one of the navigator input abnormality flag FRGn, the lateral acceleration sensor input abnormality flag FRGr, and the steering angle input abnormality flag FRGs is switched to the ON state, the ECU 20 (control unit 20d) determines “No” and proceeds to step S103. In step S103, the ECU 20 (control unit 20d) ends the execution of the automatic seat support control. Further, the ECU 20 ends the execution of the controllability determination program in step S104.

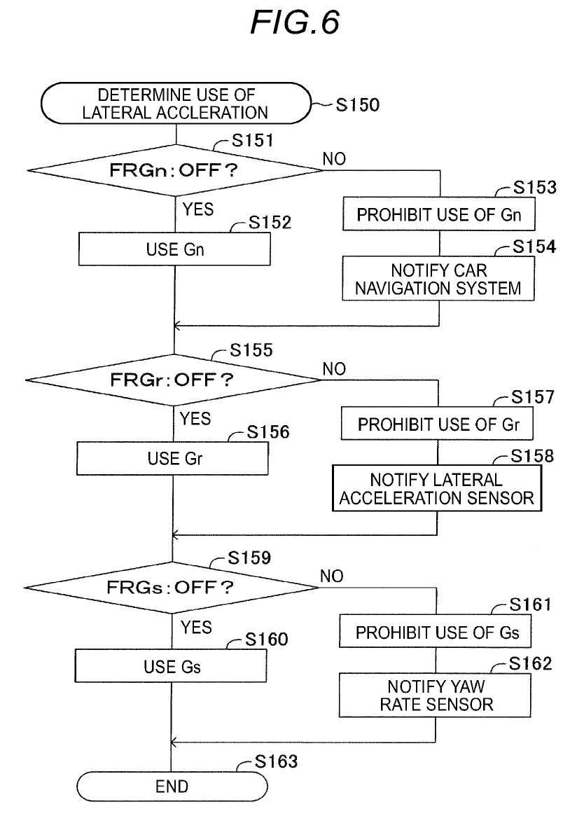

By executing the aforementioned abnormal lateral acceleration determination program, the ECU 20 (control unit 20d) may perform the automatic seat support control by excluding (without using) the lateral acceleration determined as the abnormal lateral acceleration among the navigator-estimated lateral acceleration Gn, the actual lateral acceleration Gr, and the steering-angle-estimated lateral acceleration Gs. Specifically, the ECU 20 (control unit 20d) executes a lateral acceleration usage determination program illustrated in FIG. 6.

The ECU 20 starts the lateral acceleration usage determination program in step S150, and in next step S151, the ECU 20 determines whether the navigator input abnormality flag FRGn is in the OFF state. When the navigator input abnormality flag FRGn is in the OFF state, the ECU 20 (control unit 20d) determines “Yes” and proceeds to step S152 and determines to use the navigator-estimated lateral acceleration Gn when performing the automatic seat support control. Further, when the ECU 20 determines to use the navigator-estimated lateral acceleration Gn in step S152, the ECU 20 proceeds to step S155.

Meanwhile, when the navigator input abnormality flag FRGn is in the ON state, the ECU 20 (control unit 20d) determines “No” in step S151 and proceeds to step S153. In step S153, the ECU 20 (control unit 20d) prohibits the use of the navigator-estimated lateral acceleration Gn when performing the automatic seat support control and proceeds to step S154. In step S154, the ECU 20 (control unit 20d) notifies the car navigation system 21 (in more detail, the controlling microcomputer) that the navigator-estimated lateral acceleration Gn is the abnormal lateral acceleration. Therefore, the car navigation system 21, for example, may ascertain an abnormality of the map matching for path information, and correct the map matching. When the ECU 20 performs the notification to the car navigation system 21, the ECU 20 proceeds to step S155.

In step S155, the ECU 20 (control unit 20d) determines whether the lateral acceleration sensor input abnormality flag FRGr is in the OFF state. When the lateral acceleration sensor input abnormality flag FRGr is in the OFF state, the ECU 20 (control unit 20d) determines “Yes” and proceeds to step S156 and determines to use the actual lateral acceleration Gr when performing the automatic seat support control. Further, when the ECU 20 determines to use the actual lateral acceleration Gr in step S156, the ECU 20 proceeds to step S159.

Meanwhile, when the lateral acceleration sensor input abnormality flag FRGr is in the ON state, the ECU 20 (control unit 20d) determines “No” in step S155 and proceeds to step S157. In step S157, the ECU 20 (control unit 20d) prohibits the use of the actual lateral acceleration Gr when performing the automatic seat support control and proceeds to step S158. In step S158, the ECU 20 (control unit 20d) notifies the lateral acceleration sensor 23 (in more detail, the controlling microcomputer) that the actual lateral acceleration Gr is the abnormal lateral acceleration. Therefore, the lateral acceleration sensor 23 may ascertain abnormalities of physical quantities (e.g., a voltage value and the like) related to the lateral acceleration, and correct the physical quantities. When the ECU 20 performs the notification to the lateral acceleration sensor 23, the ECU 20 proceeds to step S159.

In step S159, the ECU 20 (control unit 20d) determines whether the steering angle input abnormality flag FRGs is in the OFF state. When the steering angle input abnormality flag FRGs is in the OFF state, the ECU 20 (control unit 20d) determines “Yes” and proceeds to step S160 and determines to use the steering-angle-estimated lateral acceleration Gs when performing the automatic seat support control. Further, when the ECU 20 determines to use the steering-angle-estimated lateral acceleration Gs in step S160, the ECU 20 proceeds to step S163.

Meanwhile, when the steering angle input abnormality flag FRGs is in the ON state, the ECU 20 (control unit 20d) determines “No” in step S159 and proceeds to step S161. In step S161, the ECU 20 (control unit 20d) prohibits the use of the steering-angle-estimated lateral acceleration Gs when performing the automatic seat support control and proceeds to step S162. In step S162, the ECU 20 (control unit 20d) notifies the yaw rate sensor 24 (in more detail, the controlling microcomputer), which detects and outputs the yaw rate as a physical quantity for deriving the steering-angle-estimated lateral acceleration Gs, that the steering-angle-estimated lateral acceleration Gs derived from the yaw rate is the abnormal lateral acceleration. Therefore, the yaw rate sensor 24 may ascertain an abnormality of the yaw rate outputted as a physical quantity, and correct the yaw rate. When the ECU 20 performs the notification to the yaw rate sensor 24, the ECU 20 proceeds to step S163 and ends the execution of the lateral acceleration usage determination program.

As can be understood from the foregoing description, the seat device 1 for a vehicle according to the embodiment includes the seat 13 which has the right side support portion 16 and the left side support portion 17 that constitute side support portions configured to be pivotable to hold lateral portions of the occupant's upper body, and the ECU 20 which at least serves as a control device for controlling the operations of the right side support portion 16 and the left side support portion 17, in which the ECU 20 includes the acquisition unit 20a which acquires physical quantities from the car navigation system 21, the lateral acceleration sensor 23, and the yaw rate sensor 24 which are three or more different detection devices that detect physical quantities (voltages as electrical signals and the like) related to the lateral accelerations (the navigator-estimated lateral acceleration Gn, the actual lateral acceleration Gr, and the steering-angle-estimated lateral acceleration Gs) that occur in a direction orthogonal to the proceeding direction of the vehicle, the deviation calculating unit 20b which calculates the differential values Gd (Gdn, Gdr, and Gds) which are deviations of the navigator-estimated lateral acceleration Gn, the actual lateral acceleration Gr, and the steering-angle-estimated lateral acceleration Gs, which are a plurality of lateral accelerations derivable from the physical quantities acquired by the acquisition unit 20a, the determination unit 20c which determines, as the abnormal lateral acceleration, the lateral acceleration when the differential values Gd (Gdn, Gdr, and Gds) calculated by the deviation calculating unit 20b in respect to the navigator-estimated lateral acceleration Gn, the actual lateral acceleration Gr, and the steering-angle-estimated lateral acceleration Gs are equal to or higher than the predetermined values Gth (Gthn, Gthr, and Gths), and the control unit 20d which controls the operations of the right side support portion 16 and the left side support portion 17 in accordance with the normal lateral acceleration other than the abnormal lateral acceleration determined by the determination unit 20c in respect to the navigator-estimated lateral acceleration Gn, the actual lateral acceleration Gr, and the steering-angle-estimated lateral acceleration Gs.

In this case, the detection devices are the car navigation system 21 which is mounted in the vehicle and performs the map matching between the positions of the vehicle and the electronic map data, the lateral acceleration sensor 23 which detects the actual lateral acceleration occurring in the vehicle, and the yaw rate sensor 24 which detects the yaw rate occurring due to the turning of the vehicle, and the deviation calculating unit 20b may calculate the differential values Gd (Gdn, Gdr, and Gds) of the navigator-estimated lateral acceleration Gn which is the lateral acceleration estimated by the map matching of the car navigation system 21, the actual lateral acceleration Gr which is outputted from the lateral acceleration sensor 23, and the steering-angle-estimated lateral acceleration Gs which is the lateral acceleration estimated from the yaw rate outputted from the yaw rate sensor 24.

According to these configurations, the deviation calculating unit 20b may calculate the differential value Gdn, the differential value Gdr, and the differential value Gds in respect to the navigator-estimated lateral acceleration Gn, the actual lateral acceleration Gr, and the steering-angle-estimated lateral acceleration Gs which are three or more lateral accelerations derivable from the physical quantities (voltages which are electrical signals) acquired by the acquisition unit 20a. Further, the determination unit 20c may compare the differential value Gdn with the predetermined value Gthn, compare the differential value Gdr with the predetermined value Gthr, compare the differential value Gds with the predetermined value Gths, and determine, as the abnormal lateral acceleration, the lateral acceleration (any one of the navigator-estimated lateral acceleration Gn, the actual lateral acceleration Gr, and the steering-angle-estimated lateral acceleration Gs) corresponding to the differential value Gd equal to or higher than the predetermined value Gthn, Gthr, or Gths, among the differential values Gdn, Gdr, and Gds, and the control unit 20d may control the operations of the right side support portion 16 and the left side support portion 17 in accordance with the normal lateral acceleration other than the lateral acceleration which is determined as the abnormal lateral acceleration among the three lateral accelerations, that is, the navigator-estimated lateral acceleration Gn, the actual lateral acceleration Gr, and the steering-angle-estimated lateral acceleration Gs. Therefore, the ECU 20 may appropriately and stably control the operations of the right side support portion 16 and the left side support portion 17 by using the normal lateral acceleration.

In this case, the deviation calculating unit 20b determines, as the median Gm as a reference value, the lateral acceleration (any one of the navigator-estimated lateral acceleration Gn, the actual lateral acceleration Gr, and the steering-angle-estimated lateral acceleration Gs), which is present between a maximum value and a minimum value of the navigator-estimated lateral acceleration Gn, the actual lateral acceleration Gr, and the steering-angle-estimated lateral acceleration Gs, and the deviation calculating unit 20b calculates the differential values Gdn, Gdr, and Gds of the navigator-estimated lateral acceleration Gn, the actual lateral acceleration Gr, and the steering-angle-estimated lateral acceleration Gs with respect to the median Gm.

According to this configuration, the navigator-estimated lateral acceleration Gn, the actual lateral acceleration Gr, and the steering-angle-estimated lateral acceleration Gs, which are derived from the physical quantities acquired from the car navigation system 21, the lateral acceleration sensor 23, and the yaw rate sensor 24 which are the three different detection devices, indicate the same lateral acceleration occurring in the vehicle. Therefore, the median Gm is determined among the navigator-estimated lateral acceleration Gn, the actual lateral acceleration Gr, and the steering-angle-estimated lateral acceleration Gs, and the differential values Gdn, Gdr, and Gds with respect to the median Gm are calculated, such that the determination unit 20c may precisely determine the lateral acceleration which is more likely to be the abnormal lateral acceleration by monitoring the navigator-estimated lateral acceleration Gn, the actual lateral acceleration Gr, and the steering-angle-estimated lateral acceleration Gs. Therefore, the ECU 20 may more assuredly use the normal lateral acceleration, and as a result, the ECU 20 may appropriately and stably control the operations of the right side support portion 16 and the left side support portion 17.

In this case, the deviation calculating unit 20b calculates the differential values Gd (Gdn, Gdr, and Gds) after the acquisition unit 20a completely acquires the physical quantities from the car navigation system 21, the lateral acceleration sensor 23, and the yaw rate sensor 24 which are the detection devices.

According to this configuration, for example, the deviation calculating unit 20b may calculate the differential values Gdn, Gdr, and Gds of the navigator-estimated lateral acceleration Gn, the actual lateral acceleration Gr, and the steering-angle-estimated lateral acceleration Gs even though the lateral acceleration of which the detection interval (sampling cycle) is long is included like the navigator-estimated lateral acceleration Gn outputted from the car navigation system 21. Therefore, the determination unit 20c may assuredly determine the abnormal lateral acceleration occurring among the navigator-estimated lateral acceleration Gn, the actual lateral acceleration Gr, and the steering-angle-estimated lateral acceleration Gs.

In this case, the determination unit 20c counts the navigator-estimated lateral acceleration abnormality continuation count Cn, the actual lateral acceleration abnormality continuation count Cr, and the steering-angle-estimated lateral acceleration abnormality continuation count Cs, which are the number of times the differential values Gdn, Gdr, and Gds calculated by the deviation calculating unit 20b become equal to or higher than the predetermined values Gthn, Gthr, and Gths, and determines, as the abnormal lateral acceleration, the lateral acceleration (any of the navigator-estimated lateral acceleration Gn, the actual lateral acceleration Gr, and the steering-angle-estimated lateral acceleration Gs) when the navigator-estimated lateral acceleration abnormality continuation count Cn, the actual lateral acceleration abnormality continuation count Cr, or the steering-angle-estimated lateral acceleration abnormality continuation count Cs become equal to or larger than the determination count Cethn, Cethr, or Ceths which is the predetermined number of times.

According to this configuration, for example, due to a situation in which the vehicle changes lanes or due to disorientation of a handle operation by the driver, the differential value Gdn of the navigator-estimated lateral acceleration Gn sometimes becomes higher than the differential values Gdr and Gds of the actual lateral acceleration Gr and the steering-angle-estimated lateral acceleration Gs, and there is a likelihood that the determination unit 20c erroneously determines the navigator-estimated lateral acceleration Gn as the abnormal lateral acceleration. However, the determination unit 20c may count the navigator-estimated lateral acceleration abnormality continuation count Cn, the actual lateral acceleration abnormality continuation count Cr, and the steering-angle-estimated lateral acceleration abnormality continuation count Cs, and determine whether the navigator-estimated lateral acceleration abnormality continuation count Cn, the actual lateral acceleration abnormality continuation count Cr, and the steering-angle-estimated lateral acceleration abnormality continuation count Cs become equal to or larger than the determination counts Cethn, Cethr, and Ceths. Therefore, for example, as described above, even though the differential value Gdn of the navigator-estimated lateral acceleration Gn is temporarily higher than the predetermined value Gthn, the determination unit 20c does not determine the navigator-estimated lateral acceleration Gn as the abnormal lateral acceleration until the navigator-estimated lateral acceleration abnormality continuation count Cn is equal to or larger than the determination count Cethn. That is, the determination unit 20c may determine the abnormal lateral acceleration by providing a so-called filter, and as a result, it is possible to greatly inhibit the erroneous determination from occurring.

In this case, when, with respect to the lateral acceleration (any of the navigator-estimated lateral acceleration Gn, the actual lateral acceleration Gr, and the steering-angle-estimated lateral acceleration Gs) determined as the abnormal lateral acceleration by the determination unit 20c, it is determined by the determination unit 20c that the differential value Gd (Gdn, Gdr, or Gds) calculated by the deviation calculating unit 20b is lower than the predetermined value Gth (Gthn, Gthr, or Gths) and the lateral acceleration returns to the normal lateral acceleration from the abnormal lateral acceleration, the control unit 20d controls the operations of the right side support portion 16 and the left side support portion 17 in accordance with the returned normal lateral acceleration.

According to this configuration, the control unit 20d may use the lateral acceleration (any of the navigator-estimated lateral acceleration Gn, the actual lateral acceleration Gr, and the steering-angle-estimated lateral acceleration Gs) returned to the normal lateral acceleration from the abnormal lateral acceleration. Therefore, the control unit 20d may continue to control the operations of the right side support portion 16 and left side support portion 17.

(Modification)

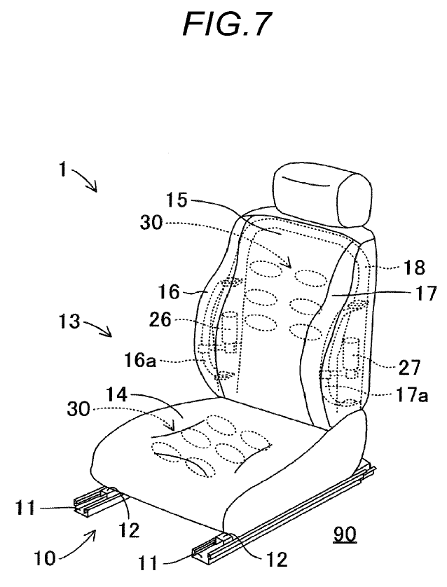

In the embodiment, the acquisition unit 20a, the deviation calculating unit 20b, and the determination unit 20c, which constitute the ECU 20 which is a control device, cooperate to determine the abnormal lateral acceleration among the navigator-estimated lateral acceleration Gn, the actual lateral acceleration Gr, and the steering-angle-estimated lateral acceleration Gs, and the control unit 20d, which constitutes the ECU 20, allows the right side support portion 16 and the left side support portion 17 provided in the seat 13 to be operated by the automatic seat support control by using only the normal lateral acceleration without using the determined abnormal lateral acceleration. By the way, vibration devices 30, of which the operation is controlled by the control unit 20d of the ECU 20 and which imparts vibratory stimulation to the occupant's back to reduce fatigue, are sometimes provided in the seat cushion 14 and the seatback 15 of the seat 13, as illustrated in FIG. 7.

As illustrated in FIG. 7, a plurality of vibration devices 30 are provided in the seat cushion 14 and the seatback 15. The vibration device 30 imparts the vibratory stimulation to the muscle of the occupant's back portion, thereby reducing fatigue that the occupant feels. In addition, fatigue includes, for example, stiffness or tension. The vibration device 30 has, for example, air sacs (not illustrated) into which air is pumped from an air pump (not illustrated), and air is supplied into and discharged from the air sacs, such that the vibratory stimulation is generated.

In a case where the vibration device 30 is provided, the control unit 20d operates the vibration device 30 in a situation in which the vehicle travels on a traveling path which is straight or gently curved, or a situation in which the vehicle is temporarily stopped because of a signal or the like, that is, a situation in which the occupant's upper body does not lean toward the left and the right because the normal lateral acceleration is lower than the normal lateral acceleration when at least the right side support portion 16 and the left side support portion 17 operate. For this reason, based on the determination result of the abnormal lateral acceleration determination program, the control unit 20d operates the vibration device 30 based on the lateral acceleration determined as the normal lateral acceleration except for the lateral acceleration determined as the abnormal lateral acceleration among the navigator-estimated lateral acceleration Gn, the actual lateral acceleration Gr, and the steering-angle-estimated lateral acceleration Gs.

Specifically, the control unit 20d determines whether the occupant's upper body leans toward the left and the right when the vehicle travels on a straight section of an expressway or the like or when the vehicle is stopped due to a signal. For this determination, the control unit 20d uses the actual lateral acceleration Gr and the steering-angle-estimated lateral acceleration Gs, which are the normal lateral acceleration, for example, when the navigator-estimated lateral acceleration Gn is the abnormal lateral acceleration, in accordance with the determination result of the aforementioned abnormal lateral acceleration determination program. Therefore, the control unit 20d may precisely determine whether the occupant's upper body leans toward the left and the right. Further, in a situation in which the occupant's upper body does not lean toward the left and the right, the control unit 20d operates the vibration device 30, thereby attenuating stiffness or tension at the occupant's back portion and reducing fatigue. Meanwhile, in a situation in which the occupant's upper body leans toward the left and the right, the control unit 20d performs the aforementioned automatic seat support control to operate the right side support portion 16 and the left side support portion 17 and stop the operation of the vibration device 30.

As can be understood from the foregoing description, in this modification, similar to the embodiment, the abnormal lateral acceleration is determined among the navigator-estimated lateral acceleration Gn, the actual lateral acceleration Gr, and the steering-angle-estimated lateral acceleration Gs, and it is possible to accurately determine whether the occupant's upper body does not lean toward the left and the right by using only the normal lateral acceleration. Further, it is possible to appropriately operate the vibration device 30 in the case where the occupant's upper body does not lean toward the left and the right. Therefore, even in this modification, similar to the embodiment, it is possible to monitor the navigator-estimated lateral acceleration Gn, the actual lateral acceleration Gr, and the steering-angle-estimated lateral acceleration Gs and appropriately and easily determine the abnormal lateral acceleration, and as a result, the ECU 20 may use only the normal lateral acceleration. Therefore, the ECU 20 may operate the vibration device 30 under an appropriate situation.

The embodiment disclosed here is not limited to the embodiment and the modification but may be variously changed without departing from the object of the embodiment disclosed here.

For example, in the embodiment, the right side support portion 16 and the left side support portion 17, which are the side support portions, are pivoted by the right side support motor 26 and the left side support motor 27. Instead, the right side support portion 16 and the left side support portion 17, which are the side support portions, may be configured to be pivoted by air sacs into which air is supplied from the air pump and from which the air is discharged.

In the embodiment and the modification, the detection devices for detecting the physical quantities related to the lateral acceleration are configured by the three detection devices, that is, the car navigation system 21, the lateral acceleration sensor 23, and the yaw rate sensor 24. In addition to or instead of this configuration, as the detection devices, for example, it is possible to use a steering angle sensor which is provided in a steering device of the vehicle and detects a steering angle, a stroke sensor which is provided in a suspension device of the vehicle and detects a suspension stroke, a vehicle height sensor which detects a vehicle height of the vehicle, and direction indicators which are operated when the vehicle turns to the right and the left and output direction indication information that indicates right and left turning directions, and the like. The lateral acceleration may be derived from the physical quantities (the steering angle of the steering wheel, a difference in stroke amount between left and right wheels of the vehicle, and a difference in vehicle height between the left and right sides of the vehicle) detected by the steering angle sensor, the stroke sensor, and the vehicle height sensor, and further, the aforementioned abnormal lateral acceleration determination program is executed in respect to lateral acceleration derived in consideration of the direction indication information outputted from the direction indicators, and as a result, it is possible to expect an effect identical to the effect of the embodiment.

In the embodiment and the modification, the navigator-estimated lateral acceleration Gn, as the physical quantity related to the lateral acceleration, is outputted directly from the car navigation system 21. Instead, for example, the car navigation system 21 may output a radius of curvature of a traveling path, an inclination angle of a road surface, or the like, as a physical quantity, to the ECU 20. In this case, the acquisition unit 20a of the ECU 20 acquires the radius of curvature, the inclination angle, and the like from the car navigation system 21 and acquires the vehicle speed from the vehicle speed sensor 22, and the deviation calculating unit 20b of the ECU 20 may calculate the navigator-estimated lateral acceleration Gn by using the radius of curvature or the inclination angle of the road surface and the vehicle speed. Therefore, even in this case, effects identical to the effects of the embodiment and the modification are obtained.

A seat device for a vehicle according to an aspect of this disclosure includes: a seat having a side support portion that is pivotable to hold a lateral portion of an occupant's upper body; and a control device configured to control at least an operation of the side support portion, in which the control device includes: an acquisition unit configured to acquire physical quantities from three or more different detection devices that detect the physical quantities related to lateral accelerations occurring in a direction orthogonal to a proceeding direction of a vehicle; a deviation calculating unit configured to calculate deviations of the lateral accelerations derivable from the physical quantities acquired by the acquisition unit; a determination unit configured to determine, as an abnormal lateral acceleration, a lateral acceleration at which the deviation calculated by the deviation calculating unit is equal to or higher than a predetermined value, among the lateral accelerations; and a control unit configured to control the operation of the side support portion in accordance with a normal lateral acceleration other than the abnormal lateral acceleration determined by the determination unit, among the lateral accelerations.

According to this configuration, in respect to three or more lateral accelerations derivable from physical quantities acquired by the acquisition unit, the determination unit may determine, as an abnormal lateral acceleration, a lateral acceleration corresponding to a deviation which is equal to or higher than a predetermined value among the deviations calculated by the deviation calculating unit, and the control unit may control the operation of the side support portion in accordance with the normal lateral acceleration other than the lateral acceleration which is determined as the abnormal lateral acceleration among the three or more lateral accelerations. Therefore, the control device may appropriately and stably control the operation of the side support portion by using the normal lateral acceleration.

In the seat device for a vehicle according to the aspect of this disclosure, the deviation calculating unit may set, as a reference value, a lateral acceleration present between a maximum value and a minimum value of the lateral accelerations, and calculate the deviation of the lateral accelerations with respect to the reference value.

In the seat device for a vehicle according to the aspect of this disclosure, the deviation calculating unit may calculate the deviation after the acquisition unit complete acquisition of the physical quantities from the detection device.

In the seat device for a vehicle according to the aspect of this disclosure, the detection devices may be a car navigation system mounted in the vehicle and configured to perform map matching between a position of the vehicle and electronic map data, a lateral acceleration sensor configured to detect an actual lateral acceleration occurring in the vehicle, and a yaw rate sensor configured to detect a yaw rate occurring by turning of the vehicle, and the deviation calculating unit may calculate the deviations of the lateral acceleration estimated by the map matching of the car navigation system, the actual lateral acceleration outputted from the lateral acceleration sensor, and the lateral acceleration estimated from the yaw rate outputted from the yaw rate sensor.

In the seat device for a vehicle according to the aspect of this disclosure, the determination unit may count the number of times that the deviation calculated by the deviation calculating unit becomes equal to or higher than the predetermined value, and determine, as the abnormal lateral acceleration, a lateral acceleration at which the number of times is equal to or larger than a predetermined number of times.

In the seat device for a vehicle according to the aspect of this disclosure, when, with respect to the lateral acceleration determined as the abnormal lateral acceleration by the determination unit, the determination unit determines that the deviation calculated by the deviation calculating unit is lower than the predetermined value and returns to the normal lateral acceleration from the abnormal lateral acceleration, the control unit may controls the operation of the side support portion in accordance with the returned normal lateral acceleration.

In the seat device for a vehicle according to the aspect of this disclosure, the seat has a vibration device that is controlled by the control device to impart vibratory stimulation to the occupant's back portion, and when the normal lateral acceleration is lower than a normal lateral acceleration at least when the side support portion is operated, the control unit operates the vibration device to impart the vibratory stimulation to the occupant's back portion.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A seat device for a vehicle, comprising:
a seat having a side support portion that is pivotable to hold a lateral portion of an occupant's upper body; and
a control device configured to control at least an operation of the side support portion,
wherein the control device includes:
an acquisition unit configured to acquire physical quantities from three or more different detection devices that detect the physical quantities related to lateral accelerations occurring in a direction orthogonal to a proceeding direction of a vehicle;
a deviation calculating unit configured to calculate deviations of the lateral accelerations derivable from the physical quantities acquired by the acquisition unit;
a determination unit configured to determine, as an abnormal lateral acceleration, a lateral acceleration at which the deviation calculated by the deviation calculating unit is equal to or higher than a predetermined value, among the lateral accelerations; and
a control unit configured to control the operation of the side support portion in accordance with a normal lateral acceleration other than the abnormal lateral acceleration determined by the determination unit, among the lateral accelerations.

2. The seat device for a vehicle according to claim 1,
wherein the deviation calculating unit sets, as a reference value, a lateral acceleration present between a maximum value and a minimum value of the lateral accelerations, and calculates the deviation of the lateral accelerations with respect to the reference value.

3. The seat device for a vehicle according to claim 1,
wherein the deviation calculating unit calculates the deviation after the acquisition unit complete acquisition of the physical quantities from the detection device.

4. The seat device for a vehicle according to claim 1,
wherein the detection devices are a car navigation system mounted in the vehicle and configured to perform map matching between a position of the vehicle and electronic map data, a lateral acceleration sensor configured to detect an actual lateral acceleration occurring in the vehicle, and a yaw rate sensor configured to detect a yaw rate occurring by turning of the vehicle, and
the deviation calculating unit calculates the deviations of the lateral acceleration estimated by the map matching of the car navigation system, the actual lateral acceleration outputted from the lateral acceleration sensor, and the lateral acceleration estimated from the yaw rate outputted from the yaw rate sensor.

5. The seat device for a vehicle according to claim 1,
wherein the determination unit counts the number of times that the deviation calculated by the deviation calculating unit becomes equal to or higher than the predetermined value, and determines, as the abnormal lateral acceleration, a lateral acceleration at which the number of times is equal to or larger than a predetermined number of times.

6. The seat device for a vehicle according to claim 1,
wherein when, with respect to the lateral acceleration determined as the abnormal lateral acceleration by the determination unit, the determination unit determines that the deviation calculated by the deviation calculating unit is lower than the predetermined value and returns to the normal lateral acceleration from the abnormal lateral acceleration, the control unit controls the operation of the side support portion in accordance with the returned normal lateral acceleration.

7. The seat device for a vehicle according to claim 1,
wherein the seat has a vibration device that is controlled by the control device to impart vibratory stimulation to the occupant's back portion, and
when the normal lateral acceleration is lower than a normal lateral acceleration at least when the side support portion is operated, the control unit operates the vibration device to impart the vibratory stimulation to the occupant's back portion.
